(19) United States
(12) Patent Application Publication
(10) Pub. No.: US 2012/0158926 A1
(43) Pub. Date: Jun. 21, 2012

(54) SYSTEM FOR RESTORING ORIGINAL CONFIGURATION AFTER TIMEOUT ADN METHOD THEREOF

(75) Inventors: Chih Chiang LAI, Taipei County (TW); Chun Kai Wang, Taipei County (TW); Kai Chen Huang, Taipei County (TW)

(73) Assignee: MOXA INC., Taipei County (TW)

(21) Appl. No.: 12/972,583

(22) Filed: Dec. 20, 2010

(51) Int. Cl. G06F 15/177

(52) U.S. Cl. 709/221

(57) ABSTRACT

A system for restoring original configuration after timeout and the method thereof are provided. After the invention determines that a local control device does not send a response message to a remote network device during a response time, and the network configuration of the local control device is restored to an original configuration backed up beforehand. The disclosed system and the method automatically restore the error configuration by a remote network device, and achieve the effect of reducing manpower and time.

### BACKGROUND OF THE INVENTION

1. Field of Invention

The invention relates to a setting restoring system and method and, in particular, to a system that restores the original setting after timeout and the method thereof.

2. Related Art

As networks become popular, network devices may exist at various corners of our environment. While installing a network device, one also needs to set network configurations so that the network device can run normally. In the early days, some person is often required to go to the physical location of the network device in order to change the network configuration thereof. After connecting a setting device and the network device, one manipulates the setting device to change the settings of the network configuration. This is likely to result in waste in manpower and time. To solve this problem, using the property that network devices can use the network to transmit data, the setting change in network configuration gradually can be done via a network connection to the control device instead of sending a person over.

During the process of setting the network configuration via a network connection to the network device, the remote network device responds with a user interface for setting the network configuration after receiving a setting request. The personnel can set new configuration settings via the user interface, and operate a local control device to send the new configuration to the remote network device. The remote network device then uses the received configuration settings to set a new network configuration. However, when there are errors in the configuration settings sent by the local control device, the remote network device may disconnect. The user then loses control of the remote network device. Before a person goes to the remote network device to reset the network configuration, the personnel cannot use the local control device to communicate with the remote network device. It may take a long time for a remote network device afar to restore normal operations. This inevitably results in waste of manpower and time.

In summary, the prior art long has the problem that when there are errors in setting a remote network device via a network, some person has to personally go to the location of the remote network device to restore the network configuration. It is therefore imperative to provide a better solution.

### SUMMARY OF THE INVENTION

In view of the foregoing, the invention provides a system that restores the original configuration after timeout and the method thereof.

The disclosed system that restores the original configuration after timeout includes: a local control device and a remote network device. The local control device sends configuration setting data. The remote network device includes: a storage module for storing the original setting data; a configuration backup module for backing up the original setting data; a configuration setting module for initializing a network configuration according to the original setting data; a remote transmission module for using the network configuration to receive the configuration setting data and for using reset network configuration to send confirmation data to the local control device after the configuration setting module resets the network configuration according to the configuration setting data; a timing determination module for determining whether the remote transmission module receives a response message returned from the local control device for data confirmation. After the configuration setting module determines according to timing determination module that the remote transmission module has to receive the response message with a response time, the backup original setting data are used to restore the network configuration.

The disclosed method of restoring the original configuration after timeout includes the steps of: initializing a network configuration by a remote network device according to original setting data; using the network configuration by the remote network device to receive configuration setting data sent from a local control device; backing up the original setting data by the remote network device; resetting the network configuration according to the configuration setting data by the remote network device; using the new network configuration by the remote network device to send confirmation data to the local control device; after the remote network device determines that no response corresponding to the confirmation data from the local control device is received before timeout, restoring the network configuration according to the original configuration.

The disclosed system and method differ from the prior art in that the remote network device first determines if the local control device returns a response before timeout. If no response is received, the original configuration backed up beforehand is used to restore the network configuration. This solves the problems in the prior art. The invention achieves the goals that the network device can automatically restore wrong settings and that manpower and time can be saved.

### BRIEF DESCRIPTION OF THE DRAWINGS

The invention will become more fully understood from the detailed description given herein below illustration only, and thus is not limitative of the present invention, and wherein:

FIG. 1 shows the disclosed system for restoring original configuration after timeout.

FIG. 2A is a flowchart of the disclosed method for restoring the original configuration after timeout.

FIG. 2B is a flowchart of one extended method for restoring the original configuration after timeout.

FIG. 2C is a flowchart of another extended method for restoring the original configuration after timeout.

FIG. 3A is a schematic view of the data transmissions and network configuration according to one embodiment of the invention.

FIG. 3B is a schematic view of the data transmissions and network configuration according to another embodiment of the invention.

### DETAILED DESCRIPTION OF THE INVENTION

The present invention will be apparent from the following detailed description, which proceeds with reference to the accompanying drawings, wherein the same references relate to the same elements.

When a user uses a local control device to set the network configuration of a remote network device, it may happen that due to some incorrect settings the local control device and the remote network device cannot communicate with each other. In that case, the invention automatically restores the original configuration to the remote network device after a certain time, so that the local control device can communicate with the remote network device for setting the network configuration again.

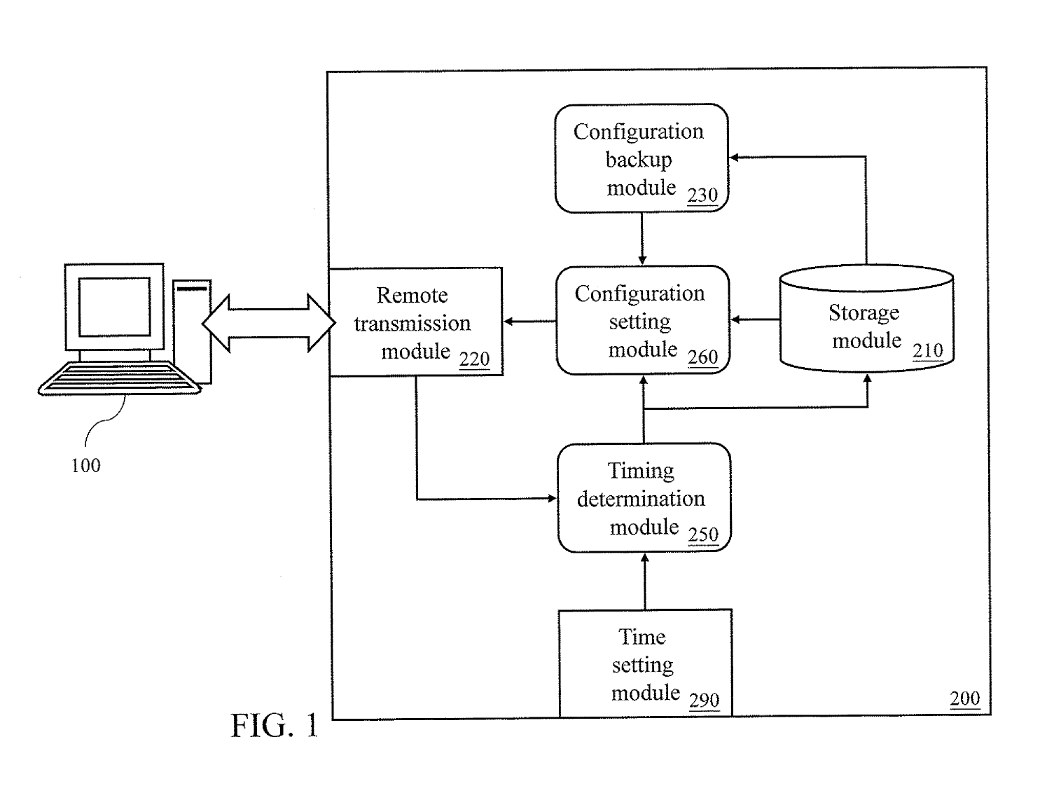

Please refer to FIG. 1 for the structure of the disclosed system for restoring original configuration after timeout. As shown in the drawing, the disclosed system includes a local control device 100 and a remote network device 200.

The local control device 100 connects to the remote network device 200, and sends the configuration setting data for the network configuration of the remote network device 200 to the remote network device 200. Generally speaking, the local control device 100 can first send a setting request to the remote network device 200 before sending the configuration setting data, so that the remote network device 200 knows that the subsequent data from the local control device 100 are configuration data. However, the invention is not restricted to this possibility. That is, the local control device 100 can also directly send the configuration setting data to the remote network device 200 without first sending a setting request.

The local control device 100 can start timing after sending the configuration setting data. Before timeout, if the local control device 100 receives a confirmation returned from the remote network device 200 about receiving the configuration setting data, the local control device 100 returns a response to the confirmation data to the remote network device 200. If after timeout the local control device 100 still has not received the confirmation from the remote network device 200, the local control device 100 determines that the connection between the local control device 100 and the remote network device 200 is broken. It can reset the connection between the local control device 100 and the remote network device 200 immediately or sometime later when necessary. The confirmation data sent by the remote network device 200 are the data in response to the configuration setting data sent by the local control device 100. Similarly, the response sent by the local control device 100 is data in response to the confirmation data. In general, the confirmation data and the response are specific combinations of symbols, which are not restricted by the invention.

The remote network device 200 mainly includes a storage module 210, a remote transmission module 220, a configuration backup module 230, a timing determination module 250, and a configuration setting module 260.

The storage module 210 stores various setting data for the remote network device 200, such as all kinds of network setting data and non-network setting data. It should be noted that the setting data stored in the storage module 210 include the original configuration that can let the remote network device 220 functions correctly.

The remote network device 220 uses a network configuration to set a data transmission environment for exchanging data with the local control device 100. The network configuration used by the remote network device 220 may be set by the original configuration stored in the storage module 210 or by the configuration setting data sent from the local control device 100.

The remote transmission module 220 can receive the configuration setting data sent from the local control device 100. It should be mentioned that the remote transmission module 220 returns a setting interface for setting the configuration setting data to the local control device 100 after receiving the setting request sent from the local control device 100. After the user of the local control device 100 sets the configuration setting data in the setting interface from the remote transmission module 220, the local control device 100 sends the configuration setting data to the remote network device 200. However, the invention is not restricted to this example. The remote transmission module 220 may receive the configuration setting data without receiving a setting request.

Besides, the remote transmission module 220 can also transmit confirmation data to the local control device 100, and receive the response to the confirmation data returned from the local control device 100.

The configuration backup module 230 backs up the original configuration used by the remote transmission module 220 to set the network configuration. The configuration backup module 230 can read the original configuration from the storage module 210 too. The invention does not impose any such restrictions. The configuration backup module 230 can also directly detect the original settings from the network configuration set by the remote transmission module 220.

Generally speaking, the configuration backup module 230 backs up the original configuration used by the remote transmission module 220 to set the network configuration after the remote transmission module 220 receives the configuration setting data sent from the local control device 100. However, the invention is not limited to this possibility. The configuration backup module 230 can also back up the original configuration at a predetermined time (12 PM everyday or 3 AM every Monday) or before shutdown or restart.

The timing determination module 250 determines whether remote transmission module 220 receives a response returned from the local control device 100 before timeout. Generally speaking, the timing determination module 250 uses a timer for timing after the remote transmission module 220 sends the confirmation data. However, the timing method used by the timing determination module 250 is not limited to the user of a timer.

When the time measured by the timing determination module 250 has reached a response time and the remote transmission module 220 still has not received any response sent from the local control device 100, the timing determination module 250 determines that no response is received by the remote transmission module 220 before timeout. If the remote transmission module 220 has received a response sent from the local control device 100, the timing determination module 250 determines that the remote transmission module 220 has received the response before timeout and stops timing (e.g., stopping the timer).

The configuration setting module 260 initializes the network configuration of the remote transmission module 220 according to the original configuration stored in the storage module 210. The configuration setting module 260 also uses the configuration setting data received by the remote transmission module 220 to reset the network configuration of the remote transmission module 220 after the remote transmission module 220 receives the configuration setting data sent from the local control device 100.

After the timing determination module 250 determines that the remote transmission module 220 does not receive any response before timeout, the configuration setting module 260 also restores the network configuration of the remote transmission module 220 according to the original configuration backed up by the configuration backup module 230 before the local control device 100 transmits the configuration setting data. The local control device 100 can then reconnect to the remote network device 200.

Besides, the invention can further include a time setting module 290. The time setting module 290 sets a response time used by the timing determination module 250 to determine whether the remote transmission module 220 has received any response. The user of the local control device 100 can also set the response time used by the timing determination module 250 according to the network conditions.

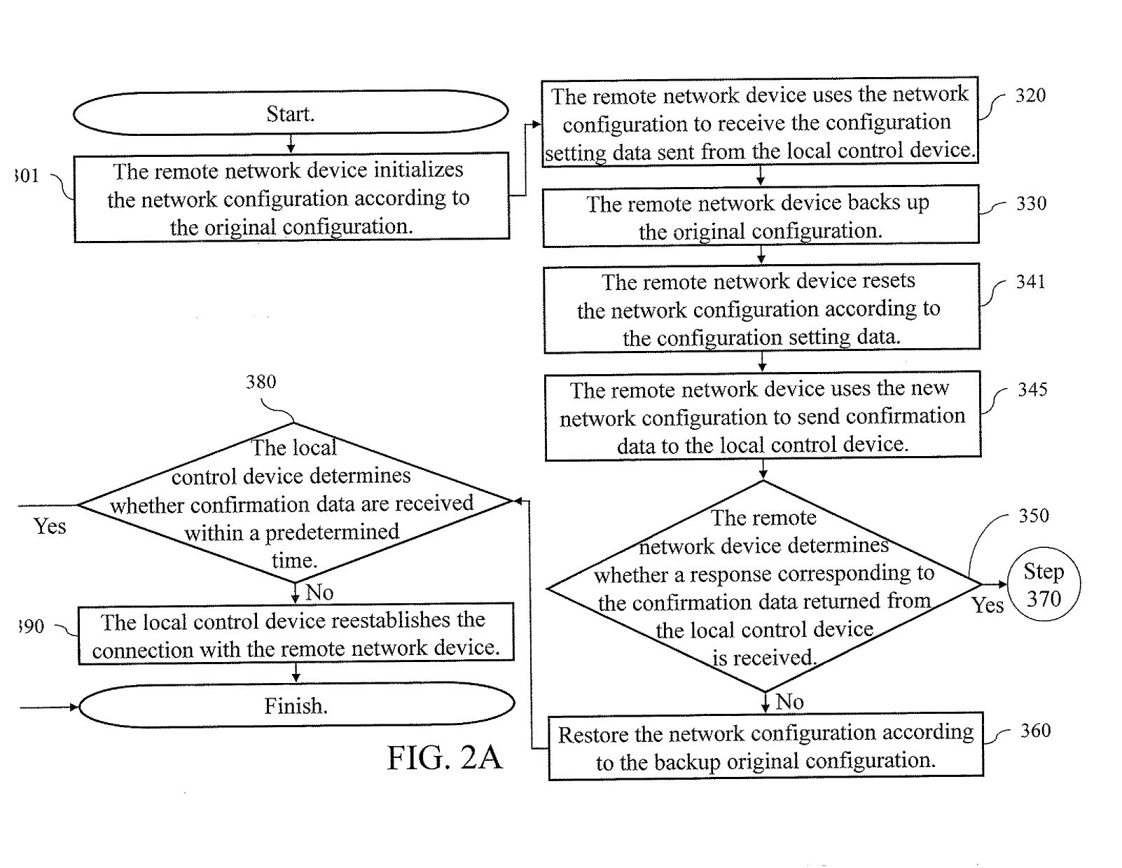

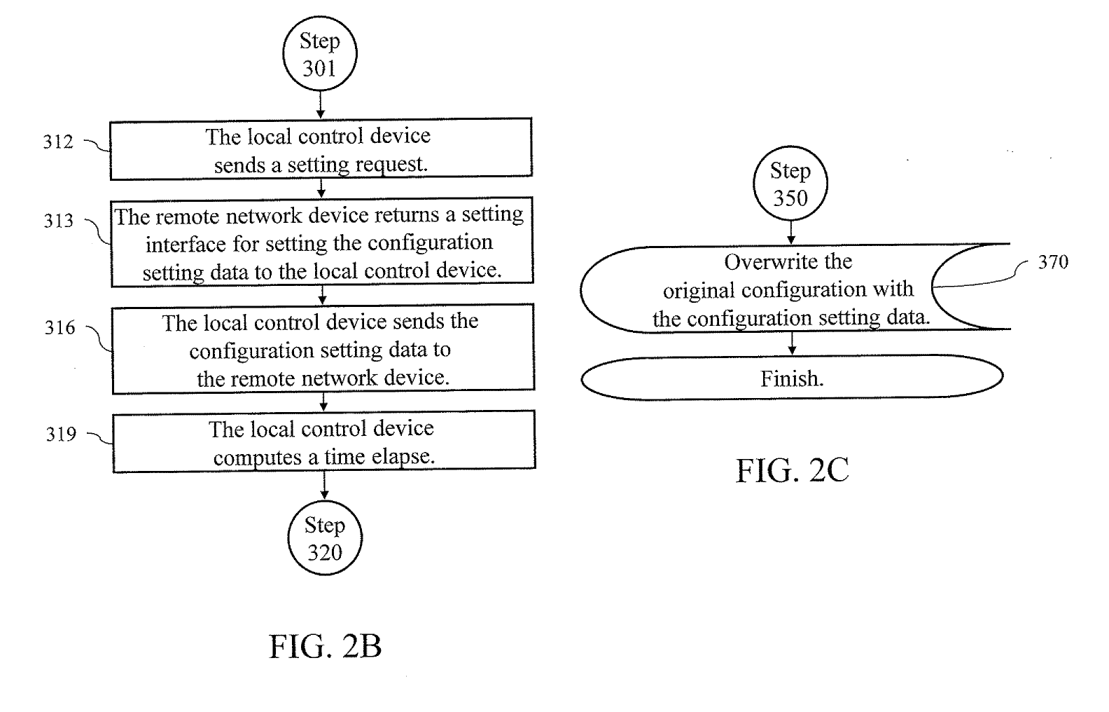

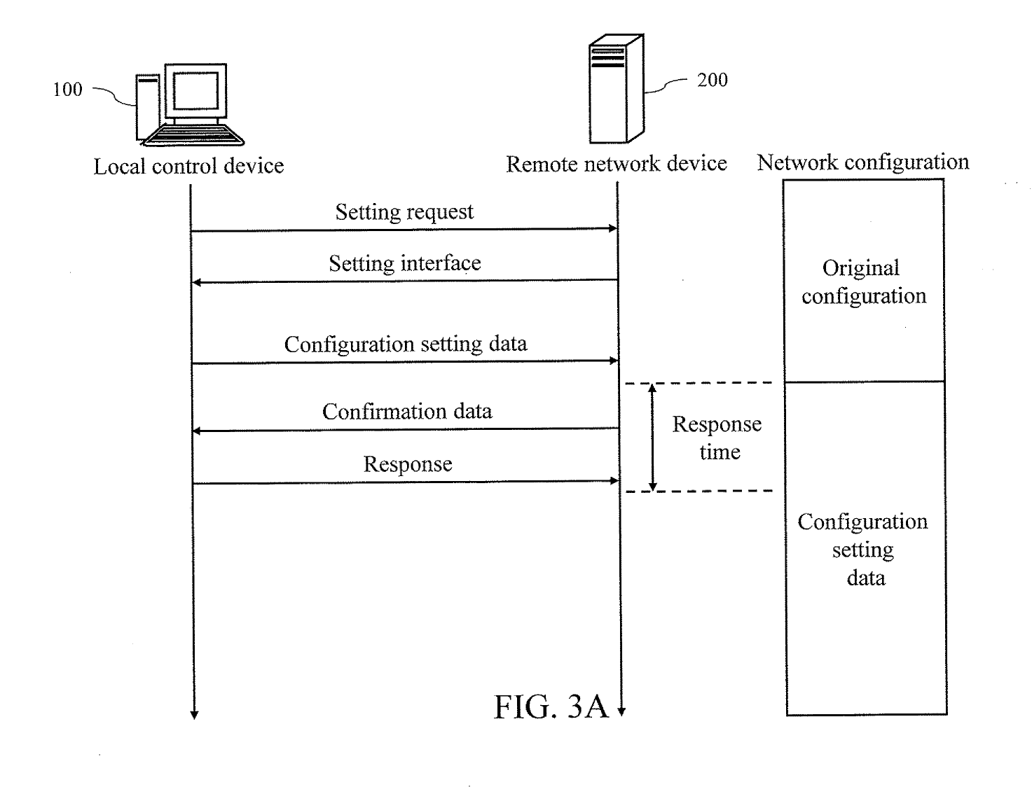

In the following, an embodiment is used to explain how the invention operates. Please refer to FIG. 2A for a flowchart of the disclosed method for restoring the original configuration after timeout. In this embodiment, the local control device 100 operated by the user is a computer. However, the invention is not limited to this particular example.

After a remote network device 200 using the invention starts, the configuration setting module 260 of the remote network device 200 can read the original configuration from the storage module 210 of the remote network device 200, and use thus obtained original settings to initialize the network configuration used by the remote transmission module 220 of the remote network device 200 (step 301). Hence, the remote network device 200 can connect to the local control device 100 via a network.

When a user wants to set the network configuration of the remote network device 200, he needs to connect the local control device 100 to the remote network device 200. In this invention, the connection between the local control device 100 and the remote network device 200 can use the protocols of link-oriented TELNET, HTTP or non-link-oriented UDP. The invention does not impose any restriction on this.

After the local control device 100 and the remote network device 200 establish a connection, the user can operate the local control device 100 to send the configuration setting data for the network configuration of the remote network device 200 to the remote network device 200. In this embodiment, the user can directly enter control commands for network configuration on the local control device 100, so that the local control device 100 directly sends the control commands to the remote network device 200. The control commands are the configuration setting data of the invention.

In practice, the invention can adopt the method shown in FIG. 2B. Before the local control device 100 sends the configuration setting data to the remote network device 200, the user can operate the local control device 100 to send a setting request to the remote network device 200 (step 312). After the remote transmission module 220 of the remote network device 200 receives the setting request from the local control device 100, a setting interface for setting the configuration setting data is read out from the storage module 210 and sent to the local control device 100 (step 313). Therefore, the user can use the setting interface to generate the configuration setting data without directly entering control commands.

It should be mentioned that if the local control device 100 uses a link-oriented protocol to connect with the remote network device 200, then the local control device 100 starts timing (step 319) after the local control device 100 sends the configuration setting data to the remote network device 200 (step 316).

After the remote transmission module 220 of the remote network device 200 receives the configuration setting data sent from the local control device 100 (step 320), the configuration backup module 230 of the remote network device 200 can back up the original configuration (step 330). In this embodiment, suppose the configuration backup module 230 reads out the original configuration from the storage module 210 of the remote network device 200, and the original configuration is copied for backup.

After the remote transmission module 220 of the remote network device 200 receives the configuration setting data sent from the local control device 100 (step 320), the configuration setting module 260 of the remote network device 200 can reset the network configuration of the remote transmission module 220 according to the configuration setting data received by the remote transmission module 220 of the remote network device 200 (step 341). After the configuration setting module 260 sets the network configuration, the remote transmission module 220 uses the new network configuration to send confirmation data to the local control device 100 (step 345).

After the remote transmission module 220 uses the new network configuration to send confirmation data to the local control device 100 (step 345), the timing determination module 250 of the remote network device 200 can determine whether the remote transmission module 220 receives a response for the confirmation data from the local control device 100 before timeout (step 350).

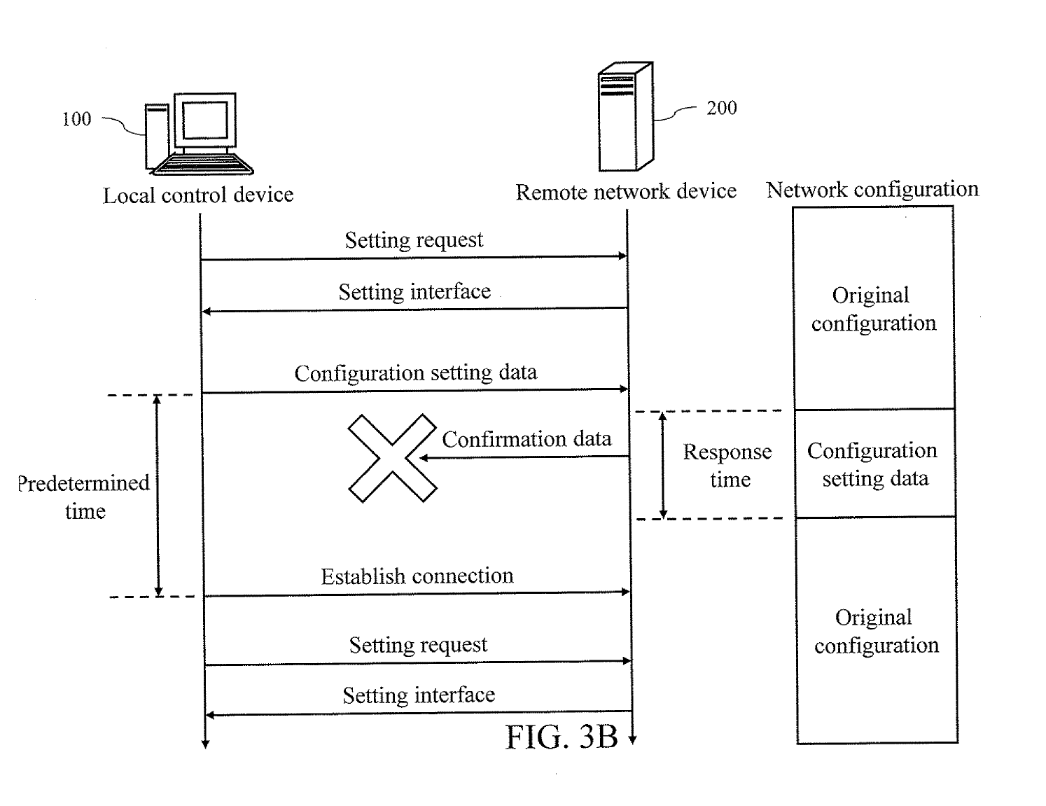

If the configuration setting data received by the remote transmission module 220 of the remote network device 200 are correct, the connection between the remote network device 200 and the local control device 100 will not be affected. As shown in FIG. 3A, the remote transmission module 220 can successfully send the confirmation data to the local control device 100, and the local control device 100 can also correctly return a response to the remote network device 200 within the response time of the timing determination module 250 of the remote network device 200. Thus, the network configuration used by the remote transmission module 220 is changed from the original configuration to the one set by the configuration setting data. As shown in FIG. 2C, the storage module 210 also uses the configuration setting data received by the remote transmission module 220 to overwrite the original configuration stored in the storage module 210 after the timing determination module 250 determines that the remote transmission module 220 has received a response within the response time (step 370). That is, the configuration setting data received by the remote transmission module 220 become the new original configuration.

If in the configuration setting data received by the remote transmission module 220 of the remote network device 200, there is an error in the IP of the remote network device 200, the remote network device 200 rejects the connection of the local control device 100, or the external connection interface of the remote network device 200 is closed, as shown in FIG. 3B, then the remote transmission module 220 will not be able to send confirmation data to the local control device 100. Therefore, the local control device 100 also cannot send a response to the remote network device 200. In this case, the timing determination module 250 of the remote network device 200 determines that no response from the local control device is received by the remote transmission module 220 within the response time.

After the timing determination module 250 of the remote network device 200 determines that no response from the local control device is received by the remote transmission module 220 within the response time, the configuration setting module 260 of the remote network device 200 uses the original configuration backed up by the configuration backup module 230 of the remote network device 200 to restore the network configuration of the remote transmission module 220 of the remote network device 200 (step 360). That is, the original configuration backed up by the configuration backup module 230 is used to reset the remote transmission module 220, so that the remote transmission module uses the original configuration again to reset its network configuration after the timing determination module 250 determines a timeout since the remote transmission module 220 uses the configuration setting data to set its network configuration, as shown in FIG. 3B.

After the configuration setting module 260 restores the network configuration of the remote transmission module 220 of the remote network device 200 according to the original configuration backed up by the configuration backup module 230 (step 360), the local control device 100 ca check whether confirmation data are received within a predetermined time after sending the configuration setting data (step 380). If the local control device 100 receives the confirmation data, it means that the connection between the local control device 100 and the remote network device 200 is not broken. The local control device 100 can use the connection parameters such as IP address and protocol corresponding to the configuration setting data sent to the remote network device 200 to establish a connection with the remote network device 200 and exchange data. If the local control device 100 does not receive the confirmation data, then it means that the local control device 100 has lost the connection with the remote network device 200.

If the local control device 100 and the remote network device 200 use a non-link-oriented protocol, such as UDP, to transmit data, after a predetermined time the local control device 100 uses the connection parameters before sending the configuration setting data to reestablish the connection with the remote network device 200 and exchange data. It should be noted that within the predetermined time, the remote transmission module 220 of the remote network device 200 uses the original configuration to reset the network configuration. Hence, the remote network device 200 can use the reset network configuration to receive the data sent from the local control device 100.

When the local control device 100 and the remote network device 200 use a link-oriented protocol, after a predetermined time the local control device 100 also uses the connection parameters before sending the configuration setting data to reestablish the connection to the remote network device 200 and exchange data. If the local control device 100 and the remote network device 200 use a protocol, such as HTTP, that reestablishes and closes the connection for data transmissions each time, the local control device 100 can always use the connection parameters before sending the configuration setting data to establish the connection with the remote network device 200 (step 390) and to send the data to the remote network device 200. If the local control device 100 and the remote network device 200 use a protocol, such as TELNET or FTP, that keeps connecting, the local control device 100 can use the connection parameters before sending the configuration setting data to reestablish the connection with the remote network device 200 (step 390) and to send the data to the remote network device 200. That is, no matter which protocol is used between the local control device 100 and the remote network device 200, even if the local control device 100 causes some error in the configuration setting data to break the connection with the remote network device 200, the invention restores the network configuration of the remote network device 200 within the predetermined time. As a result, the local control device 100 can continue to use the connection parameters before sending the configuration setting data to send data to the remote network device 200. There is no need for a person to physically go to the remote network device 200 and reset the remote network device 200.

In summary, the invention differs from the prior art in that the remote network device first determines if the local control device returns a response before timeout. If no response is received, the original configuration backed up beforehand is used to restore the network configuration. This solves the problem in the prior art that a person has to physically go to the remote network device to restore the settings. The invention achieves the goals that the network device can automatically restore wrong settings and that manpower and time can be saved.

Moreover, the disclosed method for restoring original configuration after timeout can be implemented in hardware, software, or a combination of the two. Alternatively, the invention can be realized in one computer in a centralized way or by having different components distributed in several connected computer systems.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for restoring original configuration after timeout, comprising the steps of:
using an original configuration to initialize a network configuration on a remote network device;
using the network configuration to receive a configuration setting data sent from a local control device by the remote network device;
backing up the original configuration at the remote network device;
resetting the network configuration of the remote network device according to the configuration setting data;
sending confirmation data to the local control device after the remote network device uses the new network configuration; and
restoring the network configuration according to the backup original configuration after the remote network device determines that no response corresponding to the confirmation data returned from the local control device is received within a response time.

2. The method of claim 1 further comprising the step of using the configuration setting data to overwrite the original configuration after the remote network device determines that the response is received within the response time.

3. The method of claim 1 further comprising the step of reestablishing the connection with the remote network device after the local control device determines that the confirmation data are not received within a predetermined time after sending the configuration setting data.

4. The method of claim 1 further comprising the step of returning a setting interface for setting the configuration setting data to the local control device after the remote network device receives a setting request from the local control device, before the local control device sends the configuration setting data to the remote network device.

5. A system for restoring original configuration after timeout, comprising:
a local control device for sending a configuration setting data; and
a remote network device, which includes:
a storage module for storing an original configuration;
a configuration backup module for backing up the original configuration;
a configuration setting module for initializing a network configuration according to the original configuration;
a remote transmission module for using the network configuration to receive the configuration setting data and, after the configuration setting module resets the network confirmation according to the configuration setting data, using the new network configuration to send confirmation data to the local control device; and
a timing determination module for determining whether the remote transmission module receives a response corresponding to the confirmation data returned from the local control device within a response time,
wherein after the configuration setting module determines that the remote transmission module does not receive the response within the response time, the configuration setting module restores the network configuration according to the backup original configuration.

6. The system of claim 5, wherein the storage module overwrites the original configuration with the configuration setting data after the timing determination module determines that the remote transmission module receives the response within the response time.

7. The system of claim 5, wherein the local control device further reestablishes the connection with the remote network device if the confirmation data are not received within a predetermined time.

8. The system of claim 5, wherein the local control device further sends a setting request to the remote network device and the remote network device further returns a setting interface for setting the configuration setting data to the local control device after receiving the setting request.

9. The system of claim 5, wherein the timing determination module uses a timer for measuring a time elapse and determines that the remote transmission module has not received the response before the time elapse reaches the response time, or determines that the remote transmission module receives the response if the remote transmission module receives the response before the time elapse reaches the response time.
